(19) United States
(12) Patent Application Publication
(10) Pub. No.: US 2022/0129975 A1
(43) Pub. Date: Apr. 28, 2022

(54) TECHNOLOGY CONFIGURED TO ENABLE MONITORING OF USER ENGAGEMENT WITH PHYSICAL PRINTED MATERIALS VIA AUGMENTED REALITY DELIVERY SYSTEM

(71) Applicant: MIXED REALITY SOLUTIONS PTY LTD, Queenscliff (AU)

(72) Inventor: Irene IBRAHIM, Queenscliff (AU)

(73) Assignee: MIXED REALITY SOLUTIONS PTY LTD, Queenscliff (AU)

(21) Appl. No.: 17/296,024

(22) PCT Filed: Nov. 18, 2019
(86) PCT No.: PCT/AU2019/051266

§ 371 Date: May 21, 2021

(30) Foreign Application Priority Data
Nov. 22, 2018 (AU) 2018904446

(51) Int. Cl. G06Q 30/06; G06T 19/00; G06Q 30/02; G06T 7/70; G06F 3/01; H04L 67/306; G06T 13/20

(52) U.S. Cl. CPC G06Q 30/0643; G06T 19/006; G06Q 30/0242; G06T 13/20; G06F 3/011; H04L 67/306; G06T 7/70

(57) ABSTRACT

Described herein is technology configured to enable monitoring of user engagement with physical printed materials via an augmented reality delivery system. Whilst that application of the technology is described as a primary example, it should be appreciated that the technology has additional applications. Some example embodiments relate to using AR technology as a means to enhance effectiveness of print-based advertising, primarily by allowing collection of analytics in relation to user engagement with the print-based advertising, and in some cases by allowing for users to directly purchase goods and/or services via engagement with the print-based advertising. A wide range of forms of AR experience delivery and engagement monitoring may be used.

### FIELD OF THE INVENTION

The present invention relates, in various embodiments, to technology configured to enable monitoring of user engagement with physical printed materials via an augmented reality delivery system. While some embodiments will be described herein with particular reference to those applications, it will be appreciated that the invention is not limited to such a field of use, and is applicable in broader contexts.

### BACKGROUND

Any discussion of the background art throughout the specification should in no way be considered as an admission that such art is widely known or forms part of common general knowledge in the field.

It is known to monitor user engagement with digital content, for example digital advertising delivered via the Internet. Such monitoring is of significant value in the context of performing analytics thereby to determine relationships between user engagement and other factors. There is a technical problem in the sense that existing engagement monitoring methods are limited to digitally distributed content, and unable to extend their application to content distributed via physical printed materials.

### SUMMARY OF THE INVENTION

It is an object of the present invention to overcome or ameliorate at least one of the disadvantages of the prior art, or to provide a useful alternative.

Example embodiments are described below in the section entitled “claims”.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

As used herein, the term “exemplary” is used in the sense of providing examples, as opposed to indicating quality. That is, an “exemplary embodiment” is an embodiment provided as an example, as opposed to necessarily being an embodiment of exemplary quality.

### BRIEF DESCRIPTION OF THE DRAWINGS

Embodiments of the invention will now be described, by way of example only, with reference to the accompanying drawings in which:

FIG. 1 illustrates a technology framework in accordance with one embodiment.

### DETAILED DESCRIPTION

Described herein is technology configured to enable monitoring of user engagement with physical printed materials via an augmented reality delivery system.

In overview, technology discussed herein is configured to enable monitoring of user engagement with physically printed material. For example, this may include engagement with any one or more of the following:
Advertising printed in newspapers or magazine (for example to enable analytics in a similar fashion to Internet-delivered advertising);
Advertising material printed on flyers, brochures, and the like (again, for example to enable analytics in a similar fashion to Internet-delivered advertising);
Business cards (for example to deliver a multimedia message);
Non-advertising content in newspapers or magazines (for example to enhance content that is being provided);
Packaging for an item or items (for example to provide multimedia content and/or a “terms and conditions” document for user agreement);
Other physical substances that carry printed material.

Engagement is tracked by way of enticing a user to interact with the physical substrate via a mobile device such as a smartphone or tablet, thereby to experience an Augmented Reality animation that is designed to complement the printed material. The user's interactions (for example time spent viewing an animation such as a video game, interactions with their device during an animation, and so on) are monitored and recorded for analytics purposes. This is optionally used to update data in a user profile.

The Augmented Reality animation is in some embodiments customised based on data in a user profile. This profile may include demographics for the user, known interests/habits, along with other information. When designing an AR animation, a designer preferably takes these factors into account thereby to enable delivery of a tailored experience. In some embodiments the user profile is updated in response monitoring of user engagement. This, in some cases, is implemented such that for a given example pf printed material (for example a given advertisement) this AR data presented may differ for a given user between consecutive interactions. For example, in one embodiment a user engages via AR with a printed advertisement, and the user profile is updated in response to that engagement. The user later engages via AR with the same printed advertisement (optionally printed in a different location, for example in a different magazine, in a different media form, or the like) and is presented with a different AR experience due to the change in user profile data. This optionally is implemented thereby to provide delivery of AR-based material in a progress, in a manner similar to automated email follow-up engines. Material presented to the user via the AR data is customised based on the user's previous engagement, thereby to deliver a defined logical pathway of content in response to user engagement actions.

The user interactions that are used to generate analytics data representative of user engagement include any one or more of the following:
Time spent engaging.
Location of engagement.
Characteristics of engagement with interactive modules (for example an AR video game).
Engagement preferences (e.g. playing a game or viewing information).
Repeat engagement (and characteristics of repeat engagement).
Digital heatmaps for interaction with AR objects and/or a virtual environment.
Digital heatmaps for viewing of portions of printed material (for example based on retina tracking via a front facing cameras).
Conversion rates (for example users accessing eCommerce platforms and/or purchasing products as a result of engagement with the AR data).

This is used, for example, to enable analytical monitoring of engagement with a particular printed material example (e.g. an advertisement that is delivered via one or more distribution media types), thereby to collect information such as demographics and the like, which is useful in understanding the efficacy of an advertising campaign or the like that is delivered via printed media.

An added advantage is that an advertising campaign or the like that is delivered in physically printed form can be refined and updated based on gathered intelligence (via engagement monitoring) thereby to optimise effectiveness even after physical distribution. Additionally, AR data deliver logic optionally enables split testing, whereby multiple AR experiences are tested across view base simultaneously.

According to one embodiment, a method for enabling monitoring of user engagement with a physical substrate that carries printed material, includes the processes set out below.

Firstly, the method includes defining computer executable code represented of a plurality of interactive Augmented Reality (AR) animation data sets. Each data set is executable by an AR rendering module of a user device thereby to cause display of AR data. In this regard, each data set is defined with reference to: (i) printed material on a substrate over which the AR animation will be superimposed; and (ii) AR experience goals (for example based on viewer profiles and the like).

The AR rendering module of a user device is configured to cause rendering of, on a display screen of the user device, a rendered animation superimposed on an image-capture based display of a physical substrate, wherein the rendered animation is superimposed on the image-capture based display of the physical substrate is displayed at a defined position and orientation relative to the image-capture based display of the physical substrate. The rendered animation is preferably an interactive animation that is variably rendered in response to inputs by a user of the device (for example thereby to provide a video game, in combination with game performance logic).

Each AR data set is associated with an identifier code. These codes are printed on physical substrates, and allow a computer system to identify a correct AR animation for display. That is, each of the physical substances has applied to it printed media designed to complement the AR data set associated with that identifier code.

The method includes printing a given one of the identifier codes on a plurality of physical substrates, and distributing those substrates to users. The method then includes identifying that a user device executing a prescribed software application is capturing image data of a physical substrate from which the given one of the identifier codes has been extracted, and causing the user device to display the rendered animation of the AR data set associated with the identifier code. User interactions associated with the display of the rendered animation are monitored, and data representative of the user interactions compiled. This data is preferably maintained in a server for subsequent analysis.

In some embodiments data derived from monitoring of user engagement is used to update data maintained in a user profile. This allows customisation of AR data presented to a given user in response to data derived from previous interactions. This may include presentation of offers and the like based on identified historical user engagement attributes.

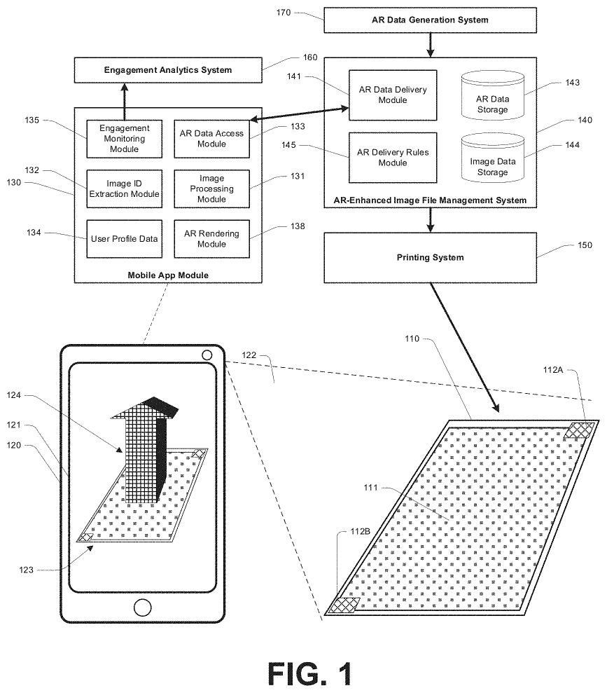

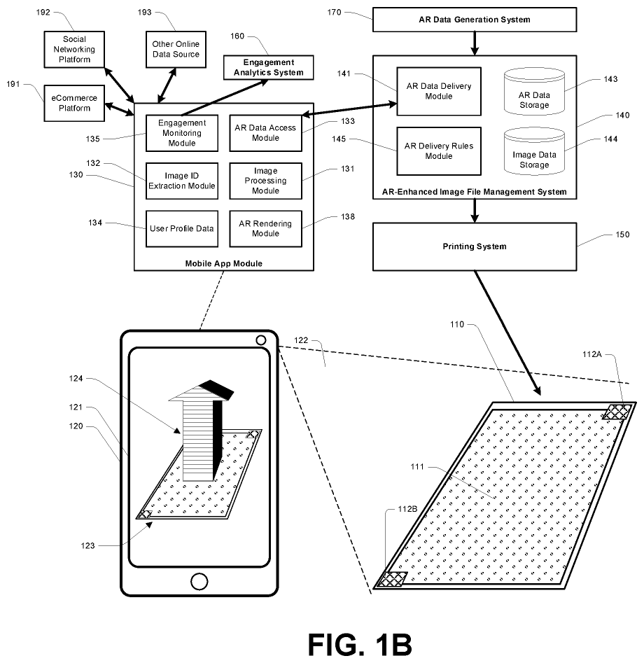

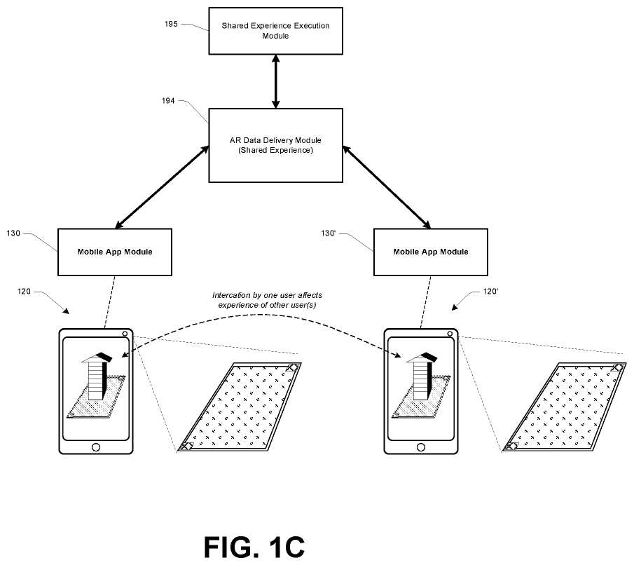

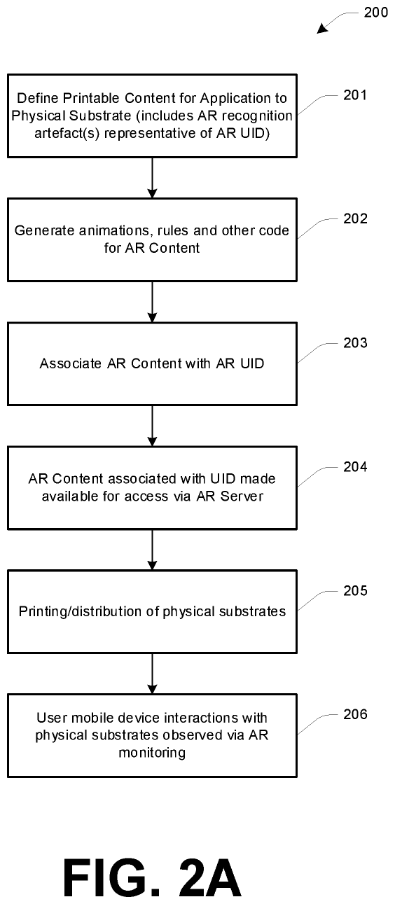

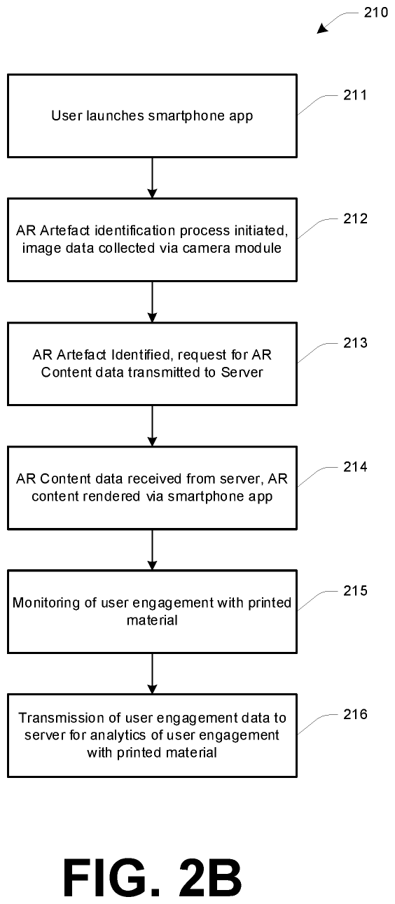

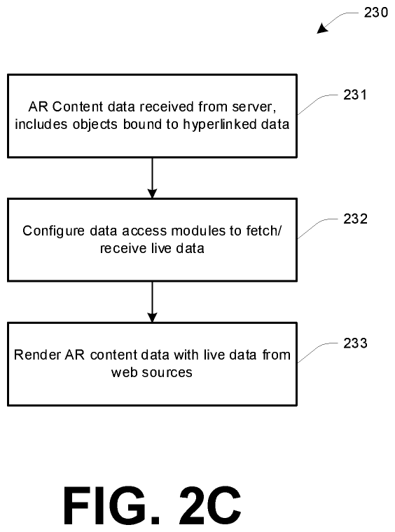

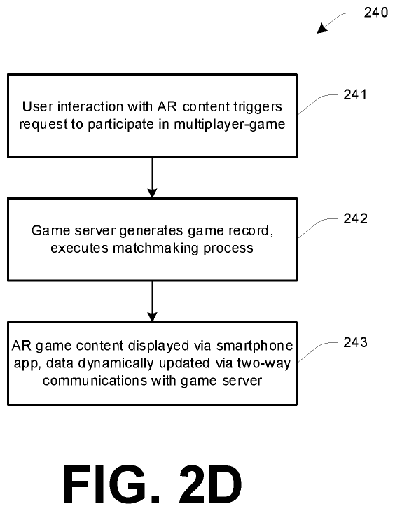

FIG. 1 illustrates a framework according to one embodiment.

The framework of FIG. 1 includes an example user device, in the form of a smartphone 120. Smartphone 120 includes a display screen 121, and an image capture device (such as a digital camera) which is not shown, and captures image data in a zone 122.

Smartphone 120 also includes a memory module coupled to a microprocessor, wherein the memory module maintains computer executable code, that when executed via the microprocessor, configure the device to execute a mobile app module 130. Mobile app module includes:
An image processing module 131, which is configured to process image data collected by the image capture device, thereby to identify image artefacts.
An image identifier extraction module 132 that is configured to process image data captured via the camera module thereby to: (i) identify presence of a graphical artefact having predefined attributes printed on the physical substrate; and (ii) extract and image identifier code from the graphical artefact.
An Augmented Reality (AR) data access module 133 that is configured to retrieve, from an AR data storage module 141 of a AR file management system 140, a set of executable AR data associated with the extracted image identifier code.
An AR rendering module 138 that is configured to cause display of, on the display screen, based on the retrieved AR data, a rendered animation superimposed on an image-capture based display of the physical substrate. The rendered animation is superimposed at a defined position and orientation, as discussed in more detail further below.
An engagement monitoring module 135 that is configured to: (i) monitor user interactions associated with the display of the rendered animation; (ii) compile data representative of the user interactions; and (iii) communicate the data representative of the user interactions to a server device 160. The compiled data may include data representative of engagement location, for example based on data retrieved from a mobile device GPS module.
A user profile data module 134, which maintains data defining attributes of the user, including demographics, historical activity, and the like. In some embodiments tis user profile data is alternately contained in a cloud-hosted repository, and/or supplemented by further profile data contained in a cloud-hosted repository.

An AR-Enhanced image file management system 140 includes an AR data storage module 143 which includes AR data sets defined by an AR data generation system 170. These include animations, and associated logic for interactive animations (for example video games based on interactive animations). System 140 also includes an image data storage module 144 which maintains data associated with printable media associated with the AR data sets (for example each printed media data set includes a graphical artefact which embeds an image ID code associated with a given one or more of the AR data sets).

The AR data generation system may be substantially any system or group of systems used to generate AR data. For example, in some embodiments this includes a system that provides AR authoring tools (for example Vuforia) and interactive content authoring tools (for example Unity, Unreal, or the like). The latter provides an authoring tools for logically programming an interactive experience involving three dimensional objects in a three-dimensional virtual space; the former enables translation of that space into a frame of reference defined by the physical substrate thereby to provide AR data at a predefined position and orientation relative to the physical substrate.

System 140 also includes an AR delivery rules module, which allows customisation of AR data to be delivered in a particular instance based on rules, which defined AR data set selection criteria in addition to an image ID code. For example, this may include user attribute maintained in the user profile data, thereby to allow customised delivery of AR content based on known attributes to a viewer. This may include any one or more of: selecting a profile-tailored AR data set; selecting profile-tailored logic; and identifying additional data for display along with the AR data (for example stored user values and the like).

Customisation based on user profile in some embodiments is achieved by a process including: (i) monitoring user engagement; (ii) updating the user profile based on that user engagement; and (iii) subsequently delivering AR content in a modified manner based on the updated user profile. This allows for AR

Customisation based on user profile in some embodiments is achieved by a process including: (i) monitoring user engagement; (ii) updating the user profile based on that user engagement; and (iii) subsequently delivering AR content in a modified manner Customisation based on user profile in some embodiments is achieved by a process including: (i) monitoring user engagement; (ii) updating the user profile based on that user engagement; and (iii) subsequently delivering AR content in a modified manner based on the updated user profile. This allows for AR customisation based on the updated user profile.

In some embodiments a logical event structure is defined, which causes delivery of particular AR data for a given image ID based on identified historical user engagement data. In this manner, each time a user engages with a particular piece of printed material (for example an advertisement), the AR experience is modified based on the logical event structure (as opposed to delivering an identical experience each time the user engages with the same advertisement). This is optionally used to in effect replicate techniques known from automated email marketing, which also uses logical event structures to automatedly sent emails containing particular content based on user interaction with previous emails. In the context of the present technology, by way of example, the logical event structure allows control over AR material delivered to a given user based on past interaction with a given advertisement (and/or other advertisements, such as advertisements for a common product/service). This control may be achieved by delivery of a different selection of AR data, or modifying the execution of code embodying an interactive AR experience (e.g. modifying execution of a video game that is delivered via the AR data).

A printing system 150 causes printing of image data from storage module 144 onto a plurality of physical substrates. An example physical substrate 110 is illustrated. This includes a primary printed region 111 (which includes artwork, blank space, and the like) and one or more graphical artefacts 112A and 112B that embed the image ID code. In some embodiments multiple artefacts are printed at defined locations thereby to facilitate determination of substrate position and orientation by module 131, such that an AR animation is displayed in a correct position and orientation. In that regard, in FIG. 1 display screen 121 shows an image-capture based display of the physical substrate 123 (in essence a live feed of image capture by the image capture device) and an AR animation 124 superimposed on the display of the physical substrate 123 in a controlled/defined position and orientation. The AR animation may be 3 dimensional (i.e. extending out of the substrate, for example using the substrate as a ground level with respect to which animated objects move) or tow dimensions (for example providing a rendering which shows additional material on the surface of substrate 111 is shown by 223 on screen 121.

Although two graphical artefacts 112A and 112B are shown in some embodiments there may be less for more graphical artefacts which provide access to the image ID code. In some embodiments there is a single artefact, and that artefact is able to inform the mobile device of position and orientation of the physical substrate.

In some embodiments the system is additionally coupled to one or more eCommerce platforms, thereby to enable a user to purchase goods and/or services associated with an AR experience directly through the software application, or via an external hyperlink fired from within the software application. This provides technology whereby a user is able to make an online purchase from engagement with printed material (for example a printed advertisement). Additionally, in some embodiments interactions with the eCommerce platform is monitored thereby to update a user's user profile, thereby to allow customisation of AR data in future interactions.

It will be appreciated that the technology described above provides a means by which users are able to interact with physical substrates containing printed material via a smartphone device or the like, and that engagement to be monitored and measured for subsequent analytical purposes.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

It should be appreciated that in the above description of exemplary embodiments of the invention, various features of the invention are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1.-14. (canceled)

15. A computer-implemented method that enables monitoring of user engagement with printed content including printed content distributed via magazines, newspapers, packaging and brochures, the method including:
distributing a plurality of articles carrying respective copies of a common printed content item, wherein each copy of the printed content item includes a common graphical artefact, wherein the common graphical artefact is associated with a set of Augmented Reality (AR) content data in a cloud-hosted system;
executing an engagement application at a plurality of user mobile devices, wherein each executing instance of the engagement application is configured to:
process image data captured via a camera module of the mobile device thereby to identify presence of the graphical artefact when the printed content item is brought into a field of view of the camera module;
obtain from the cloud-hosted system at least a subset of set of Augmented Reality (AR) content data associated with the graphical artefact;
cause display of, on a display screen of the mobile device, based on the obtained AR content data, a rendering of interactive AR content superimposed on an image-capture based display of the physical substrate, wherein the rendered animation is superimposed on the image-capture based display of the physical substrate is displayed at a defined position and orientation relative to the image-capture based display of the physical substrate;
at a server device, collecting data representative of user engagement from the plurality of user mobile devices with the interactive content rendered from the Augmented Reality (AR) content data associated with the graphical artefact, thereby to generate analytics representative of user engagement with multiple copies of the common printed content item.

16. A device configured to enable monitoring of user engagement with a physical substrate that carries printed material, the device including:
a camera module that is configured to capture image data of capture area;
a display screen;
a microprocessor;
a memory module coupled to the microprocessor, wherein the memory module maintains computer executable code, that when executed via the microprocessor, configure the device to provide:
an image identifier extraction module that is configured to process image data captured via the camera module thereby to: (i) identify presence of a graphical artefact having predefined attributes printed on the physical substrate; and (ii) extract an image identifier code from the graphical artefact;
an Augmented Reality (AR) data access module that is configured to retrieve, from an AR data storage module, a set of executable AR data associated with the extracted image identifier code;
an AR rendering module that is configured to cause display of, on the display screen, based on the retrieved AR data, a rendered animation superimposed on an image-capture based display of the physical substrate, wherein the rendered animation is superimposed on the image-capture based display of the physical substrate is displayed at a defined position and orientation relative to the image-capture based display of the physical substrate;
an engagement monitoring module that is configured to: (i) monitor user interactions associated with the display of the rendered animation; (ii) compile data representative of the user interactions; and (iii) communicate the data representative of the user interactions to a server device, such that the data representative of the user interactions is associated with image identifier code, thereby to associate engagement interactions with particular printed material.

17. A device according to claim 16 wherein the rendered animation is an interactive animation that is variably rendered in response to inputs by a user of the device.

18. A device according to claim 16 wherein the AR data storage module maintains multiple sets of AR data associated with a given image identifier code, and wherein a specific one of those sets of AR data is selected for delivery to the device based on one or more attributes of a user associated with the device.

19. A device according to claim 18 wherein the one or more attributes of a user associated with the device are defined in a user profile, wherein the user profile is stored in the memory module of the device and/or in a cloud-hosted data store.

20. A device according to claim 16 the data store is maintained by a cloud-hosted server AR data management system

21. A system configured to enable monitoring of user engagement with a physical substrate that carries printed material, the system including:
a communications module that enables communication between the system and a plurality of user devices, wherein each user device includes:
a camera module that is configured to capture image data of capture area;
a display screen;
a microprocessor;
a memory module coupled to the microprocessor, wherein the memory module maintains computer executable code, that when executed via the microprocessor, configure the device to provide:
an image identifier extraction module that is configured to process image data captured via the camera module thereby to: (i) identify presence of a graphical artefact having predefined attributes printed on the physical substrate; and (ii) extract and image identifier code from the graphical artefact;
an Augmented Reality (AR) data access module that is configured to retrieve, from an AR data storage module, a set of executable AR data associated with the extracted image identifier code;
an AR rendering module that is configured to cause display of, on the display screen, based on the retrieved AR data, a rendered animation superimposed on an image-capture based display of the physical substrate, wherein the rendered animation is superimposed on the image-capture based display of the physical substrate is displayed at a defined position and orientation relative to the image-capture based display of the physical substrate;
an engagement monitoring module that is configured to: (i) monitor user interactions associated with the display of the rendered animation; (ii) compile data representative of the user interactions; and (iii) communicate the data representative of the user interactions to a server device, such that the data representative of the user interactions is associated with image identifier code, thereby to associate engagement interactions with particular printed material.
wherein the system provides the AR storage module.

22. A system according to claim 21 wherein the rendered animation is an interactive animation that is variably rendered in response to inputs by a user of the device.

23. A system according to claim 21 wherein the AR data storage module maintains multiple sets of AR data associated with a given image identifier code, and wherein a specific one of those sets of AR data is selected for delivery to the device based on one or more attributes of a user associated with the device.

24. A system according to claim 23 wherein the one or more attributes of a user associated with the device are defined in a user profile, wherein the user profile is stored in the memory module of the device and/or in a cloud-hosted data store.

25. A system according to claim 24 wherein the one or more attributes of the user are updated responsive to the monitoring of user interactions associated with the display of the rendered animation.

26. A system according to claim 25 wherein the updating of the one or more attributes of the user causes customised selection and/or execution of AR data for rendering in relation to a given image ID code which causes variations in AR data selection and/or execution on consecutive interactions with a common image ID code.

27. A system according to claim 21 wherein the system includes a module that provides access to an eCommerce platform thereby to enable a user of the user device to purchase goods and/or services based on interaction with the rendered AR data.

28. A system according to claim 21 wherein the data store is maintained by a cloud-hosted server AR data management system.

29. A method for enabling monitoring of user engagement with a physical substrate that carries printed material, the method including:
defining computer executable code represented of a plurality of interactive Augmented Reality animation data sets, wherein each data set is executable by an AR rendering module of a user device thereby to cause display of, on a display screen of the user device, a rendered animation superimposed on an image-capture based display of a physical substrate, wherein the rendered animation is superimposed on the image-capture based display of the physical substrate is displayed at a defined position and orientation relative to the image-capture based display of the physical substrate;
associating each AR data set with an identifier code;
printing a given one of the identifier codes on a plurality of physical substrates, wherein each of the physical substances has applied to it printed media designed to complement the AR data set associated with that identifier code;
identifying that a user device executing a prescribed software application is capturing image data of a physical substrate from which the given one of the identifier codes has been extracted;
causing the user device to display the rendered animation of the AR data set associated with the identifier code, such that the animation is rendered superimposed on an image-capture based display of the physical substrate, wherein the rendered animation is superimposed on the image-capture based display of the physical substrate is displayed at a defined position and orientation relative to the image-capture based display of the physical substrate;
monitoring user interactions associated with the display of the rendered animation, such that the data representative of the user interactions is associated with image identifier code, thereby to associate engagement interactions with particular printed material; and
compiling data representative of the user interactions.

30. A method for enabling monitoring of user engagement with a physical substrate that carries printed material, the method including:
distributing multiple physical substrates carrying a common printed content item, wherein the common printed content item is associated in a database with a specified set of AR content;
at a first mobile device, reading a graphical artefact from a first one of the physical substrates carrying the printed content item, and in response obtaining from a server data from the specified set of AR content, and rendering an AR interactive game based on that data;
at a second mobile device, reading a graphical artefact from a second one of the physical substrates carrying the printed content item, and in response obtaining from a server data from the specified set of AR content, and rendering an AR interactive game based on that data;
a cloud-hosted game server device communicating with the first mobile device and the second mobile device, such that the server receives data representative of an interaction at one of the mobile devices with its instance of the AR interactive game, and in response to that data representative of an interaction causes a change in state of the AR interactive game executing at the other of the mobile devices.

31. A method according to claim 29 including maintaining a record of interaction with the AR content at the first mobile device and the second mobile device, thereby to enable analysis of engagement with the printed content items.

32. A method for enabling user engagement with a physical substrate that carries printed material, the method including:
distributing multiple physical substrates carrying a common printed content item, wherein the common printed content item is associated in a database with a specified set of AR content;
at a first mobile device, reading a graphical artefact from a first one of the physical substrates carrying the printed content item, and in response obtaining from a server data from the specified set of AR content, and rendering an AR interactive animation based on that data;
via the rendering of the AR interactive animation, rendering an interactive object that represents a functionality to purchase goods and/or services;
in response to a predefined interaction with the interactive object that represents a functionality to purchase goods and/or services, triggering a process that causes a purchase transaction for the user in respect of the goods and/or services.

33. A method according to claim 32 wherein the process that causes a purchase transaction for the user in respect of the goods and/or services includes a process that completes a purchase transaction using pre-stored user data including payment information and delivery information.

34. A method according to claim 32 wherein the process that causes a purchase transaction for the user in respect of the goods and/or services includes a process that redirects the user to display that renders a user interface for facilitating completion of a purchase transaction.
